(19) United States
(12) Patent Application Publication
(10) Pub. No.: US 2026/0167012 A1
(43) Pub. Date: Jun. 18, 2026

(54) MOTOR CONTROL DEVICE

(71) Applicant: LG INNOTEK CO., LTD., Seoul (KR)

(72) Inventor: Ju Hyung HA, Seoul (KR)

(21) Appl. No.: 19/123,493

(22) PCT Filed: Oct. 6, 2023
(86) PCT No.: PCT/KR2023/015367

§ 371 Date: Apr. 23, 2025

(30) Foreign Application Priority Data
Oct. 25, 2022 (KR) 10-2022-0138770
Oct. 25, 2022 (KR) 10-2022-0138771

(51) Int. Cl. B60L 15/00; B60L 15/04

(52) U.S. Cl. CPC B60L 15/007; B60L 15/04; B60L 2210/10; B60L 2240/527

(57) ABSTRACT

A motor control device according to an embodiment of the present invention comprises: a substrate including a low-voltage area, a high-voltage area spaced apart from the low-voltage area, and an insulating area disposed between the low-voltage area and the high-voltage area; and a capacitor module disposed in the high-voltage area, wherein the high-voltage area includes a connection terminal configured by one pin map, and the capacitor module has a pin formed at a position corresponding to the connection terminal.

### TECHNICAL FIELD

The present invention relates to a motor control device.

### BACKGROUND ART

Electric vehicles (xEVs) are broadly categorized into hybrid electric vehicles (HEVs), plug-in hybrid electric vehicles (PHEVs), and battery-powered electric vehicles (BEVs). Most HEVs or PHEVs must be designed with inverters with a maximum voltage of 600 V, while BEVs must be designed with inverters with a maximum voltage of 1200 V.

Specifically, in order to drive a drive motor in an electric vehicle, a battery (high-voltage battery) is provided to supply the power required to drive the drive motor by repeatedly charging and discharging while the vehicle is running, and an inverter is provided to rotate the drive motor with the power of the battery.

An inverter is a power conversion device for driving a drive motor and charging a battery. It converts the power of the battery to drive a motor for power assistance, and performs a function of power conversion to charge the battery during regenerative braking.

Since a high-voltage (100V or more) motor driving voltage and a low-voltage (12V) control power are inputted to the inverter in parallel, a separation distance must be formed for insulation between the high-voltage and the low-voltage. In addition, parts suitable for the voltage must be used, and the size of the parts increases as the voltage increases.

Since a high-voltage (100V or more) motor driving voltage and a low-voltage (12V) control power are inputted to the inverter in parallel, a separation distance must be formed for insulation between the high-voltage and the low-voltage. In addition, there is a problem that an expensive and complex isolated DC/DC converter is required to transmit the control signal generated from the low-voltage power source to the high-voltage area, and a digital isolator is required for isolated signal transmission.

### DETAILED DESCRIPTION OF THE INVENTION

### Technical Subject

The technical problem to be solved by the present invention is to provide a motor control device that is compatible with different voltages.

In addition, a technical problem to be solved by the present invention is to provide a motor control device that uses a single input power source as a power source for driving and controlling a motor.

### Technical Solution

For solving the above described technical problem, a motor control device according to an embodiment of the present invention comprises: a substrate including a low-voltage area, a high-voltage area being spaced apart from the low-voltage area, and an insulating area being disposed between the low-voltage area and the high-voltage area; and a capacitor module being disposed in the high-voltage area, wherein the high-voltage area includes a connection terminal being configured by one pin map, and the capacitor module has a pin formed at a position corresponding to the connection terminal.

The capacitor module includes a substrate, components being disposed on one surface of the substrate, and a pin being disposed on the other surface of the substrate, and at least some of the components may vary in at least some of the size and the type depending on the magnitude of the input voltage.

Components being disposed on one surface of the capacitor module include a Y capacitor, a filter, and a DC capacitor, and at least some of the size and type of the DC capacitor may vary depending on the magnitude of the input voltage.

It includes a power module being disposed in the high-voltage area of the substrate, and at least some of the size and type of the power module may vary depending on the magnitude of the input voltage.

The connection terminal of the high-voltage area includes a first connection terminal to which the capacitor module is connected and a second connection terminal to which the power module is connected, and the power module may have a pin formed at a position corresponding to the second connection terminal.

In order to solve the above technical problem, in a capacitor module disposed in a motor control device according to an embodiment of the present invention, the capacitor module includes: a substrate; components being disposed on one surface of the substrate; and a pin disposed on the other surface of the substrate and formed at a position corresponding to a connection terminal of the motor control device, wherein at least some of the components may vary in at least some of the size and the type depending on the magnitude of the input voltage.

The components include a Y capacitor, a filter and a DC capacitor, and at least some of the size and type of the DC capacitor may vary depending on the magnitude of the input voltage.

In order to solve the above technical problem, a motor control device according to an embodiment of the present invention comprises: a substrate including a low-voltage area, a high-voltage area being spaced apart from the low-voltage area, and an insulating area being disposed between the low-voltage area and the high-voltage area; and a connection terminal in which the high-voltage area is configured as one pin map, wherein the connection terminal may be connected to a first capacitor module or a second capacitor module.

The first capacitor module and the second capacitor module may include a substrate; components being disposed on one surface of the substrate; and a pin being disposed on the other surface of the substrate and formed at a position corresponding to the connection terminal.

It includes a power module disposed in the high-voltage area of the substrate, and the connection terminal may include a first connection terminal to which the first capacitor module or the second capacitor module is connected and a second connection terminal to which the power module is connected.

In order to solve the above technical problem a motor control device according to an embodiment of the present invention comprises: a substrate including a low-voltage area, a high-voltage area being separated from the low-voltage area, and an insulating area being disposed between the low-voltage area and the high-voltage area; a 3-phase switching module being disposed in the high-voltage area and connected to a motor; a control unit being disposed in the high-voltage area and controlling the driving of the motor; and a DC/DC converter being disposed in the high-voltage area and converting power being inputted to the high-voltage area into motor control power.

The DC/DC converter may be a non-isolated DC/DC converter.

It may include a communication module being disposed in the insulating area and connected to a communication line being inputted to the low-voltage area and the control unit.

It may include a communication module being disposed in the low-voltage area and connected to a communication line being inputted to the low-voltage area; and an isolator being disposed in the insulating area and connected to the communication module and the control unit.

A Y-capacitor and a filter may be disposed between the power source being inputted to the high-voltage area and the DC/DC converter, and a DC capacitor may be disposed between the DC/DC converter and the 3-phase switching module.

The size of the low-voltage area can be formed to be smaller than the size of the high-voltage area.

The number of pins of the connector being connected to the high-voltage area may be greater than the number of pins being connected to the low-voltage area.

The connector being connected to the high-voltage area may include four pins being connected to a power input line, a power ground line, and two interlock lines, and the connector being connected to the low-voltage area may include two pins being connected to a reception line and a transmission line being connected to the communication module.

For solving the above technical problem, in a motor control device including a low-voltage area, a high-voltage area being separated from the low-voltage area, and an insulating area being disposed between the low-voltage area and the high-voltage area, the motor control device according to an embodiment of the present invention comprises: a 3-phase switching module being disposed in the high-voltage area and connected to a motor; a control unit being disposed in the high-voltage area and controlling the driving of the motor; a DC/DC converter being disposed in the high-voltage area and converting power being inputted to the high-voltage area into motor control power; and a communication module being disposed in the insulating area and connected to a communication line input to the low-voltage area and the control unit.

The DC/DC converter may be a non-isolated DC/DC converter.

### Advantageous Effects

In the past, the insulation separation distance had to be formed differently depending on the size of the high-voltage being inputted to the motor control device, and the parts had to be changed to match the voltage, but according to the present embodiments, the size of the low-voltage area and the entire substrate are used in common, and the parts that must be changed depending on the size of the input voltage are modularized so that all voltages being inputted in various ways can be compatible within the same substrate.

This allows cost savings and freedom in design changes through commonization of the low-voltage area of the substrate.

In addition, the motor control device according to the present embodiments is a motor control device that uses a single input power source as a power source for driving and controlling the motor. Since the input power source is changed to a high-voltage single power source and signals move in a single area, expensive insulating components are not required for signal transmission, and power can be generated using a non-isolated DC/DC converter.

In addition, the complexity of the circuit configuring the motor control device is reduced, which can save time and cost during design and improve the stability and reliability of the vehicle.

In addition, as the number of components being disposed in the low-voltage area is minimized, the low-voltage area can be designed smaller, minimizing the insulating area, and freedom in component design and efficient use of space in the high-voltage area become possible.

### BRIEF DESCRIPTION OF DRAWINGS

FIGS. 1 (a) and (b) is a diagram for describing a conventional motor control device.

FIGS. 2 to 4 (b) are views for describing a motor control device according to a first embodiment of the present invention.

FIG. 5 is a diagram for describing a conventional motor control device.

FIGS. 6 to 9 are views for explaining a motor control device according to a second embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or disposed in “on (above)” or “below (under)” of each component, “on (above)” or “below (under)” means that it includes not only the case where the two components are directly in contact with, but also the case where one or more other components are formed or disposed between the two components. In addition, when expressed as “on (above)” or “below (under)”, the meaning of not only an upward direction but also a downward direction with respect to one component may be included.

A high voltage (100V or more) as a motor driving power source and a low voltage (12V) as a control power source are inputted to the inverter in parallel. Here, the input high voltage may be divided into 600V, which is the maximum withstand voltage of most of the hybrid (HEV) and the plug-in hybrid (PHEV), and 1200V, which is the maximum withstand voltage of an electric vehicle (BEV) driven only by a battery.

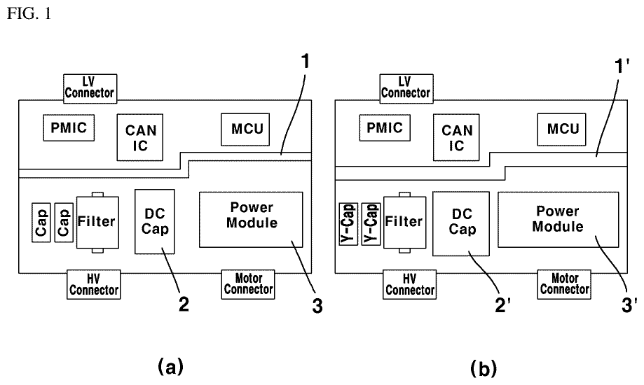

FIG. 1 is a diagram for explaining a conventional motor control device. Specifically, FIG. 1(a) is a block diagram of an inverter of a motor control device having a withstand voltage of 600 V in a high-voltage area, and FIG. 1(b) is a block diagram of an inverter of a motor control device having a withstand voltage of 1200 V in a high-voltage area. Here, the motor control device of FIG. 1(a) can be covered by a motor control device having a maximum withstand voltage of 600 V since an actual high voltage of 400 V is inputted, and the motor control device of FIG. 1(b) can be covered by a motor control device having a maximum withstand voltage of 1200 V since an actual high voltage of 800 V is inputted. The numerical values for the magnitude of the voltage are merely exemplary and may, of course, vary.

Referring to FIGS. 1(a) and 1(b), the configuration of the components and substrates corresponding to the voltage varies when the magnitude of an input high voltage varies. Specifically, the size of the insulating area separating a low-voltage area and a high-voltage area changes. The separation distance 1′ of the insulating area when the high voltage is 1200 V must be formed larger than the separation distance 1 of the insulating area when the high voltage is 600 V.

In addition, depending on the magnitude of the input high voltage, the size and type of the components disposed in the high voltage area change, and the spacing between each component also changes. Electronic components with different specifications may be disposed depending on the magnitude of the input high voltage. For example, as the magnitude of the input high voltage increases, the sizes of the DC capacitor and the power module may increase. On the other hand, in configurations such as Y-capacitors and CMC filters, electronic components with different specifications may be disposed even if the sizes of the components are the same. The sizes of the DC capacitor 2′ and the power module 3′ when the high voltage is 1200 V may be larger than the sizes of the DC capacitor 2 and the power module 3 when the high voltage is 600 V.

That is, there is a problem that the configuration and arrangement of parts within the circuit substrate of the motor control device must be individually designed depending on the magnitude of the high-voltage being inputted. Therefore, through the present embodiment, parts being disposed in the low-voltage area are commonized, and parts being disposed in the high-voltage area are modularized so that various high-voltage sizes can be responded to simply by replacing the modules.

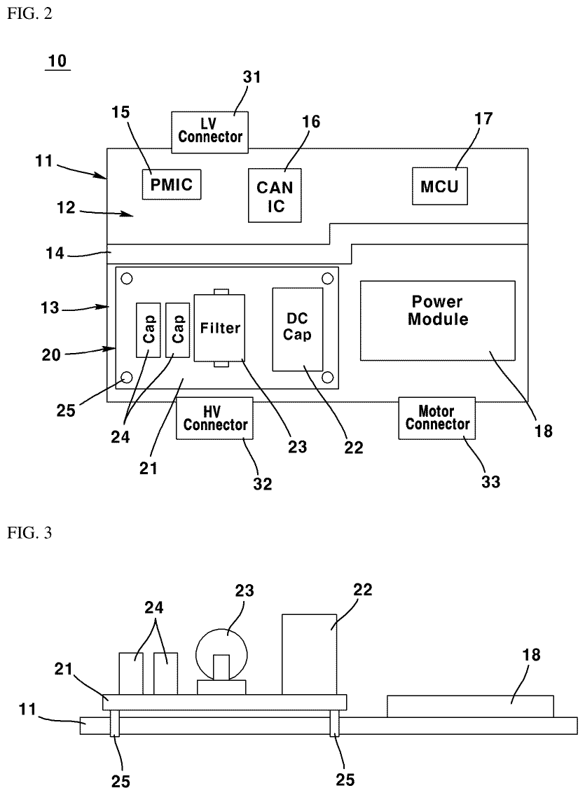

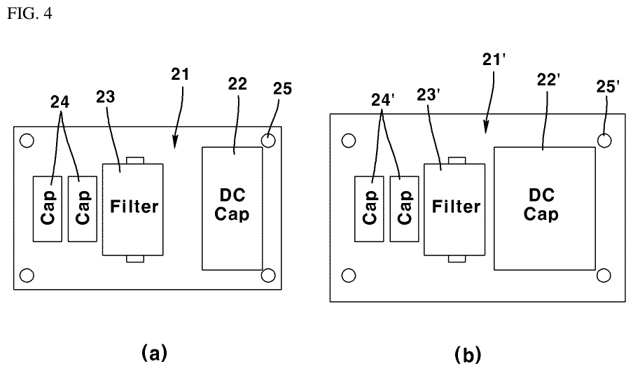

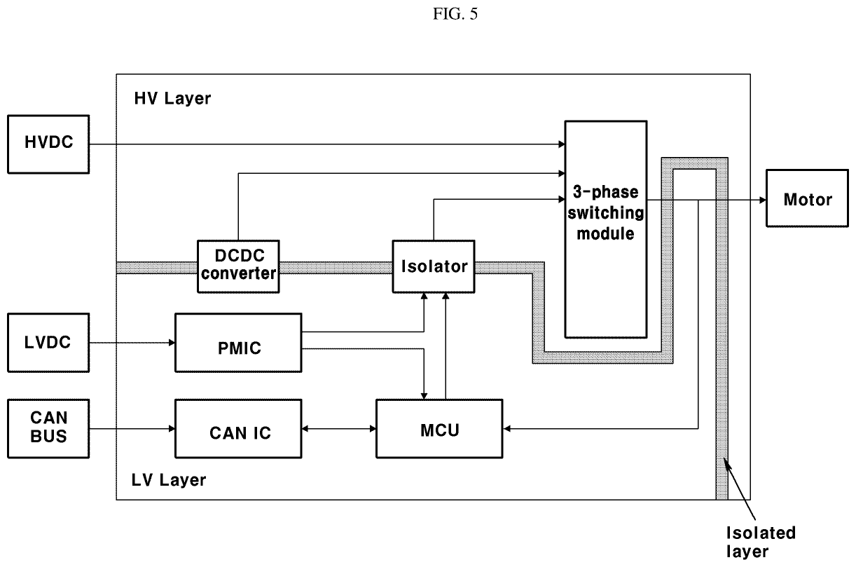

FIGS. 2 to 4 are diagrams for explaining a motor control device according to a first embodiment of the present invention.

A motor control device 10 according to a first embodiment of the present invention may include a substrate 21, a capacitor module 20, and a connection terminal.

A motor control device 10 according to a first embodiment of the present invention may be a motor control device that drives or brakes a motor and forms a shift-by-wire system (hereinafter referred to as SBW). The SBW is composed of a switched reluctance motor (hereinafter referred to as SRM) and an SBW control unit (SCU), and the SRM and the SCU may be configured as an integrated unit. The SRM and the SCU may also be configured independently. The motor control device 10 according to the present embodiment may operate as an SCU that forms an SBW.

The substrate 21 may include a low-voltage area 12, a high voltage area 13 being spaced apart from the low-voltage area 12, and an insulating area 14 being disposed between the low-voltage area 12 and the high-voltage area 13. Here, the motor control device 10 is described as being configured in one substrate 21, but is not necessarily limited thereto, and may be formed in a layer structure in which a plurality of substrates are stacked. In this case, each of the plurality of substrates may be divided into a low-voltage area, a high-voltage area, and an insulating area, and only a part of the plurality of substrates may be divided into at least one among a low-voltage area, a high-voltage area, and an insulating area.

The low-voltage area 12 is an area in which components using a low voltage as a power source are disposed. The magnitude of the low voltage being inputted to the low-voltage area 12 may be 12V, but is exemplary and is not limited thereto. A component communicating a control signal with the vehicle and generating a signal for controlling the power module 18 disposed in the high-voltage area 13 may be disposed in the low-voltage area 12.

For example, a power management integrated circuit (PMIC) 15, a CAN IC 16, and a micro control unit (MCU) 17 being connected to a low-voltage connector (LV connector) 31 may be disposed in the low-voltage area 12. The types, sizes, and spacing of components being disposed in the low-voltage area 12 may be fixed regardless of the magnitude of a high voltage being inputted to the high-voltage area 13. That is, the block diagram in the low-voltage area 12 may be common regardless of the magnitude of a high voltage being inputted to the high-voltage area 13.

The high-voltage area 13 is an area in which components using a high voltage power source are disposed. The magnitude of the high voltage being inputted to the high-voltage area 13 may be 600V or 1200V, but this is exemplary and is not limited thereto. In the high-voltage area 13, a component for generating a signal for driving and controlling a motor may be disposed.

In the following description, for convenience, among the high voltages applied to the high-voltage region, the lower-magnitude voltage of 600V may be referred to as a first voltage, and the higher-magnitude voltage of 1200V may be referred to as a second voltage. The magnitude of high voltages being inputted to the high-voltage area 13 may vary, and it is natural that there may be a third voltage, a fourth voltage, and the like.

An insulating area 14 may be disposed between the low-voltage area 12 and the high-voltage area 13 for insulation. Although FIG. 2 illustrates that there are no components being disposed in the insulating area 14, components such as an isolator and a DC/DC converter may be disposed for transmission and reception of signals between components being disposed in the low-voltage area 12 and components being disposed in the high-voltage area 13.

The distance between the low-voltage area 12 and the high-voltage area 13 may be formed according to the maximum magnitude of a high voltage being inputted. For example, if a high voltage being inputted is the first voltage, the distance of the insulating area 14 should be formed as a first distance, and if a high voltage being inputted is a second voltage, the distance of the insulating area 14 should be formed as a second distance, the motor control device 10 according to the present embodiment may form the distance of the insulating area 14 as a second distance based on when a high voltage being inputted is a second voltage. The second distance may be a value larger than the first distance. That is, in order to modularize the substrate 21 of the motor control device 10 regardless of the high voltage being inputted, the insulating area 14 may be formed based on the maximum magnitude of the high voltage being inputted.

A capacitor module 20 and a power module 18 may be disposed in the high-voltage area 13.

The capacitor module 20 may include a substrate 21, a component being disposed on one surface of the substrate 21, and a pin 25 being disposed on the other surface of the substrate 21.

The capacitor module 20 may include a first capacitor module in which the magnitude of a high voltage being inputted is a first voltage and a second capacitor module in which the magnitude of a high voltage being inputted is a second voltage. The types of components being disposed in the first capacitor module and components being disposed in the second capacitor module may be the same, but specifications may be different and sizes may be different. For example, at least some of the components being disposed in the second capacitor module may be larger than the components being disposed in the first capacitor module.

The sizes of the substrate 21 of the first capacitor module and the substrate 21′ of the second capacitor module may be different from each other. For example, the size of the substrate 21′ of the second capacitor module may be larger than the size of the substrate 21 of the first capacitor module. Since the first capacitor module and the second capacitor module should be identically connected to the connection terminal of the substrate 21 of the motor control device 10, the positions of the pins 25 being formed on one surface of the substrate 21 may be the same.

The components being disposed in the capacitor module 20 may include a Y-capacitor 24, a filter 23, and a DC capacitor 22. At least a portion of the components being disposed in the capacitor module 20 may vary in size and type according to the input voltage magnitude. Here, the type may refer to a specification of each component. For example, the Y-capacitor and the filter for the first voltage may not operate at the second voltage. The Y-capacitor and the filter for the second voltage may not operate smoothly at the first voltage.

The filter 23 may be a common mode filter (CM) or a CMC filter. The DC capacitor 22 may be a film capacitor. The Y-capacitor 24 and the filter 23 may be components for filtering noise of a signal being inputted, and the DC capacitor 22 may be a component for supplying a stable power source to the motor control device 10.

At least a part of the size and type of the DC capacitor 22 may vary according to the magnitude of a voltage being inputted. Here, the type may refer to a specification of each component. For example, the DC capacitor for the first voltage may not operate at the second voltage. The DC capacitor for the second voltage may not operate smoothly at the first voltage. Also, the size of the DC capacitor 22 being disposed in the second capacitor module may be larger than the size of the DC capacitor 22 being disposed in the first capacitor module.

The power module 18 is a power conversion device and may be a component comprising a switching element (IGBT) for power conversion and a freewheeling diode (FWD). The power module 18 may be connected to a motor through a motor connector 33. At least a part of the magnitude and type of the power module 18 may vary according to the magnitude of a voltage being inputted. Here, the type may refer to a specification. For example, the power module for the first voltage may not operate at the second voltage. The power module for the second voltage may not operate smoothly at the first voltage. In addition, the size of the power module 18 to which the second voltage is inputted may be larger than the size of the power module 18 to which the first voltage is inputted. The power module 18 may be a pin-to-pin component being connected to the connection terminal of the substrate 21 of the motor control device 10.

The high-voltage area 13 may include a connection terminal being configured with a single pin map. The connection terminal of the high-voltage area 13 may include a first connection terminal to which the capacitor module 20 is connected and a second connection terminal to which the power module 18 is connected. The capacitor module 20 may have a pin 25 formed at a position corresponding to the first connection terminal. The power module 18 may have a pin formed at a position corresponding to the second connection terminal. The pin 25 of the capacitor module 20 may be connected by soldering to the connection terminal of the high-voltage area 13. The pin of the power module 18 may be connected by soldering to the connection terminal of the high-voltage area 13.

In other words, the capacitor module 20 can be detached from the substrate 21 by including a connection terminal being configured with a single pin map on one surface of the substrate 21 of the high-voltage area 13, so when manufacturing the motor control device 10, the motor control device 10 where the first capacitor module or the second capacitor module where the first voltage is inputted with a high voltage is placed can be selectively manufactured.

In addition, the motor control device 10 can be manufactured by selectively attaching a power module 18 that uses the first voltage as an input power source or a power module 18 that uses the second voltage as an input power source when manufacturing the motor control device 10.

A component being disposed in the capacitor module 20 may be connected to a high voltage and a signal being inputted from a high voltage connector 32 through a first connection terminal of the high-voltage area 13, and the power module 18. The power module 18 may be connected to the motor connector 33 through a second connection terminal of the high-voltage area 13.

In the past, depending on the magnitude of the high voltage being inputted to the motor control device, the insulation separation distance had to be formed differently and the components had to be changed according to the voltage, but according to the present embodiments, the low-voltage area and the size of the entire substrate are used in common, and the components that must be changed according to the magnitude of the voltage being inputted are modularized so that various input voltages can all be compatible within the same substrate, and costs can be saved through common use of the low-voltage area of the substrate, and design changes can be made freely.

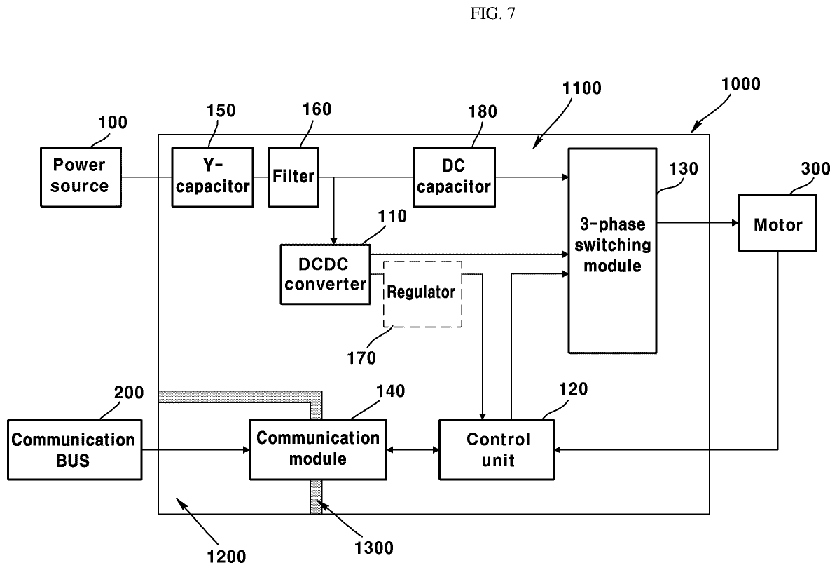

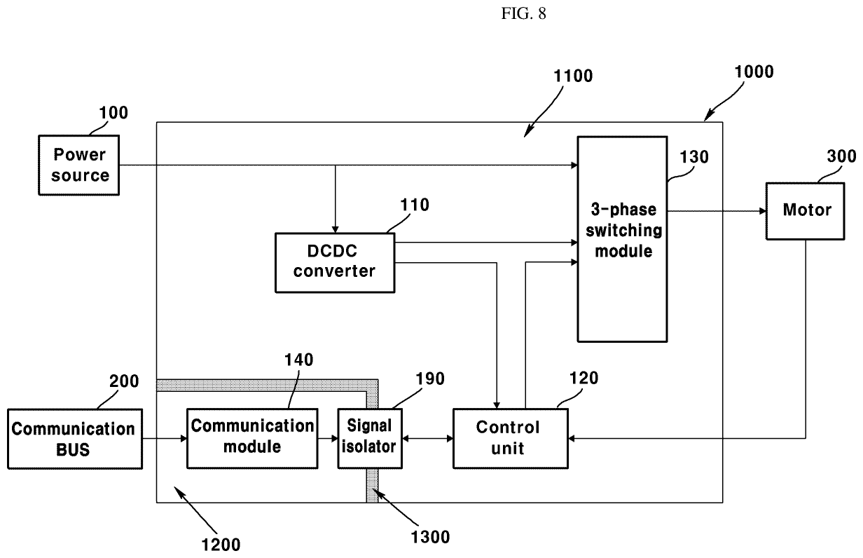

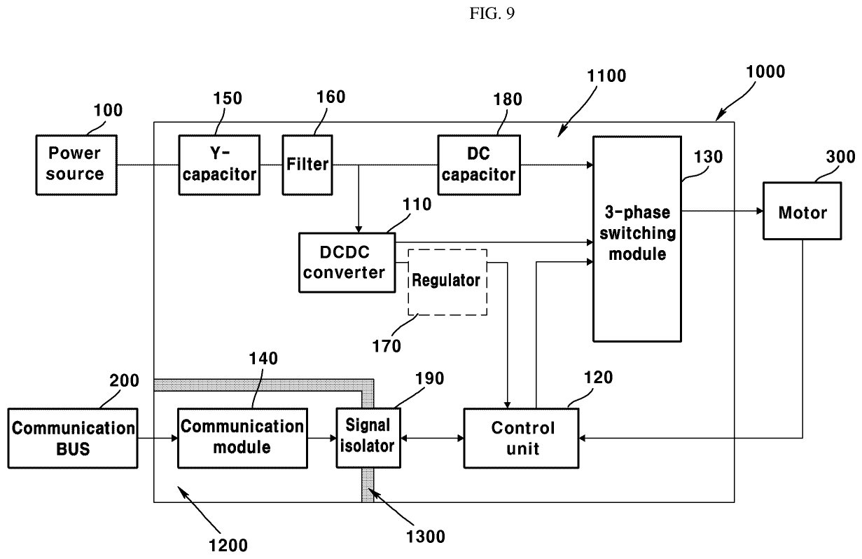

As described above, the motor control device according to the first embodiment of the present invention has been described with reference to FIGS. 1 to 4. Hereinafter, the motor control device according to a second embodiment of the present invention will be described with reference to FIGS. 5 to 9. The detailed description of the motor control device according to a second embodiment of the present invention is based on the names, terms, and functions of the motor control device according to a first embodiment of the present invention and the detailed descriptions of each embodiment, and may be the same as or different from each other.

In the inverter, high voltage (over 100 V) is inputted in parallel as a motor driving power source and low voltage (12 V) is inputted as a control power source. A separation distance for insulation between the high voltage and low voltage and an isolated DC/DC converter for transmitting the low voltage power source to the high voltage area are required. In addition, there is a problem that an expensive and complex isolated DC/DC converter is required to transmit the control signal generated from the low voltage power source to the high voltage area, and a digital isolator is required for the isolated signal transmission.

The inverter is input with high voltage (100V or more) as motor driving power and low voltage (12V) as control power. High voltage and low voltage switches require an isolated DC/DC converter, and low voltage power must be transferred from the high voltage region. In addition, in order to transfer the control signal generated from the low voltage power to the high voltage region, an isolated DC/DC connector with a combined price is required, and a digital isolator is required for isolated signal transfer, which is problematic.

More specifically, referring to the existing motor control device illustrated in FIG. 5, a high-voltage power source (HVDC) is inputted into the high-voltage area (HV Layer), and a low-voltage power source (LVDC) and a communication signal of a CAN bus are inputted into the low-voltage area (LV Layer). The three-phase switching module that controls motor operation can selectively use the high-voltage power source and the low-voltage power source.

Specifically, a power management IC (PMIC) and a micro control unit (MCU) are disposed in the low-voltage area. The PMIC, a semiconductor for power management, can convert the low-voltage power source being inputted and transmit it to the MCU and the 3-phase switching module, and the MCU can receive communication signals from the CAN BUS and transmit control signals to each component of the motor control device.

That is, since a high-voltage power source and a low-voltage power source are input to the motor control device and the two power sources are selectively used to drive and control the motor, there is a problem that the number of components that must be disposed in the motor control device increases and the size of the insulating area (isolated layer) that must be secured also increases.

The motor control device according to the present embodiment receives only a high-voltage power source as input, and disposes only a communication module in the low-voltage area, thereby eliminating unnecessary components and reducing manufacturing costs and securing design freedom, minimizing the low-voltage area and insulating area, and increasing space utilization within the substrate.

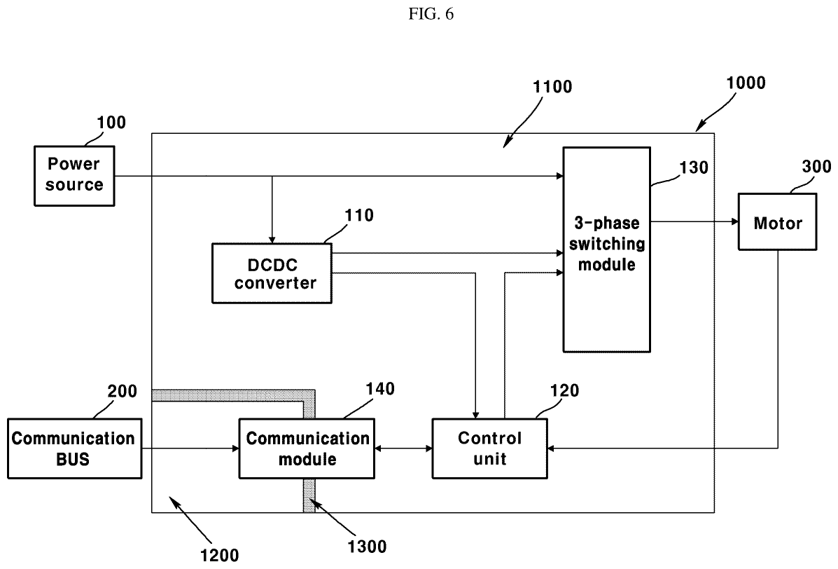

FIGS. 6 to 9 are views for explaining a motor control device according to a second embodiment of the present invention.

The motor control device 1000 according to a second embodiment of the present invention may comprise a substrate, a three-phase switching module 130, a control unit 120, and a DC/DC converter 110, and may include a communication module 140.

A motor control device 1000 according to a second embodiment of the present invention may be a motor control device that drives or brakes a motor and forms a shift-by-wire system (hereinafter referred to as SBW). The SBW is composed of a switched reluctance motor (hereinafter referred to as SRM) and an SBW control unit (SCU), and the SRM and the SCU may be configured as an integrated unit. The SRM and the SCU may also be configured independently. The motor control device 1000 according to the present embodiment may operate as an SCU that forms an SBW.

The substrate may include a low-voltage area 1200, a high-voltage area 1100 being spaced apart from the low-voltage area 1200, and an insulating area 1300 being disposed between the low-voltage area 1200 and the high-voltage area 1100. Here, the motor control device 1000 is described as being configured in one substrate, but is not necessarily limited thereto, and may be formed in a layer structure in which a plurality of substrates are stacked. In this case, each of the plurality of substrates may be divided into a low-voltage area, a high-voltage area, and an insulating area, and only a part of the plurality of substrates may be divided into at least one among a low-voltage area, a high-voltage area, and an insulating area.

The distance between the low-voltage area 1200 and the high-voltage area 1100 may be formed according to the magnitude of a voltage being inputted to the high-voltage area 1100. For example, as the magnitude of a voltage being inputted to the high-voltage area 1100 increases, the separation distance of the insulating area 1300 may increase.

The 3-phase switching module 130 may be disposed in the high-voltage area 1100 and connected to the motor 300.

Specifically, the 3-phase switching module 130 may be configured as a 3-phase switch, and the 3-phase switching module 130 may be configured as a 3-phase bridge operating in different phases U, V, and W. The 3-phase switching module 130 may be configured as six bridges. When configured with six switching elements, the 3-phase switching module 130 includes three high-side switches and three low-side switches, and the high-side switch and the low-side switch, which are paired with each other, are complementarily conducted to operate the motor in 3-phase.

Here, the switching element may be configured as any one of an insulated gate bipolar transistor (IGBT), a MOSFET, a transistor, and a relay as a power switching element that drives the motor. For example, if the switching element is an IGBT, each IGBT comprising the 3-phase switching module 130 may be configured with a gate, a carrier, and an emitter, and may be turned on and off according to a gate signal being applied to the gate. The 3-phase switching module 130 may be 3-phase energized, 2-phase energized, or 1-phase energized, and may be all turned off.

The control unit 120 may be disposed in the high-voltage area 1100 and may control driving of the motor 300.

Specifically, the control unit 120 applies a gate signal to energize one switching element of at least one phase among the 3-phase switching module 130 and electrically drives the motor 300. The control unit 120 may apply a gate signal to the switching element through a gate driver unit (GDU).

The control unit 120 may receive the converted power source from the DC/DC converter 110. The control unit 120 may generate a control signal for driving the motor 300 according to a signal inputted from the communication module 140. The control unit 120 may detect whether the motor 300 is operating normally through a current detection sensor, a position sensor, and the like disposed in the motor 300.

The DC/DC converter 110 may be disposed in the high-voltage area 1100, and may convert a power source being inputted to the high-voltage area 1100 into a motor control power source. The DC/DC converter 110 may be a non-insulated DC/DC converter.

Specifically, there are two types of DC/DC converters: non-isolated and isolated. Isolated DC/DC converters are insulated so that the input (primary side) and output (secondary side) are separated, and the output voltage is low, so the risk of electric shock is low. Non-isolated DC/DC converters are used in cases where insulation is not required, such as voltage conversion within the same substrate, because there is conduction between the input and output; however, since the output voltage is high voltage, there may be a risk of electric shock. The number of components comprising an isolated DC/DC converter is greater than the number of components comprising a non-isolated DC/DC converter, and as a result, the price of an isolated DC/DC converter is higher than that of a non-isolated DC/DC converter.

That is, according to a second embodiment of the present invention, since the DC/DC converter 110 receives only the power source being inputted to the high-voltage area 1100, it may be configured as a non-insulating DC/DC converter being disposed in the high-voltage area 1100 and disposed in the same substrate so that insulation is not required.

In the high-voltage area 1100, a Y-capacitor 150 and a filter 160 may be disposed between the power source 100 being inputted to the high-voltage area 1100 and the DC/DC converter 110. In the high-voltage area 1100, a DC capacitor 180 may be disposed between the DC/DC converter 110 and the 3-phase switching module 130.

The Y-capacitor 150 and the filter 160 may be components for filtering noise of a power source signal being inputted to a high-voltage. The filter 160 may be a common mode filter (CM) or a CMC filter. The DC capacitor 180 may be a film capacitor. The DC capacitor 180 may be a component for supplying a stable power source to the motor control device 1000.

A low-dropout (LDO) linear regulator 170 being connected to an output terminal of the DC capacitor 180 may be disposed in the high-voltage area 1100. The LDO is a regulator that may be disposed on a circuit having a small voltage difference between input and output, and is an IC that serves to step down a power source inputted. That is, the LDO may be included to receive a voltage converted by the DC capacitor 180 and to convert the voltage into a voltage smaller than a voltage inputted when it is outputted to the control unit 120 and the 3-phase switching module 130.

The communication module 140 may be connected to a communication line being inputted to the low-voltage area 1200 and a control unit 120 being disposed in the high-voltage area 1100.

The communication module 140 is a module being connected to a communication system in a vehicle and may be one among CAN, LIN, FlexRay, and Ethernet. When the communication module 140 performs CAN communication, the communication module 140 may be connected to a communication line being connected to a CAN BUS 200 outside the motor control device 1000. Accordingly, the communication module 140 may transmit and receive various signals to and from an electronic control unit (ECU) being disposed outside the motor control device 1000.

The communication module 140 may be disposed in the insulating area 1300. The communication module 140 being disposed in the insulating area 1300 may be an isolated transceiver including an insulating function, and a separate isolator may not be disposed.

The communication module 140 may be disposed in the low-voltage area 1200. When the communication module 140 is disposed in the low-voltage area 1200, a signal insulator 190 being connected to the communication module 140 and the control unit 120 may be disposed in the insulating area 1300. Here, the signal insulator 190 may separate a low voltage signal and a high voltage signal of a signal moving between a low voltage and a high voltage, thereby preventing damage to a low voltage component and preventing noise from being generated.

The size of the low-voltage area 1200 may be smaller than the size of the high-voltage area 1100. The size of the low-voltage area 1200 may be smaller than the size of the high-voltage area 1100 within the substrate. The number of connector pins being connected to the high-voltage area 1100 may be greater than the number of pins of a connector being connected to the low-voltage area 1200.

The number of pins of the connector being connected to the high-voltage area 1100 may be at least four. The connector being connected to the high-voltage area 1100 may include four pins being connected to a power source input line, a power source ground line, and two interlock lines. The interlock line is a line being connected to the interlock circuit, and the interlock circuit refers to a circuit that electrically blocks incorrect signals from being inputted to the motor to prevent dangerous situations such as incorrect motor driving order or accidentally turning on the motor's reverse switch during a power outage.

At least two or more connector pins being connected to the low-voltage area 1200 may be formed. The connector being connected to the low-voltage area 1200 may include a reception line being connected to the communication module 140 and two pins being connected to the transmission line. When the communication module 140 is a CAN communication system, the reception line and the transmission line may be a CAN H line and a CAN L line. That is, when compared with a motor control device that simultaneously receives inputs of a conventional high-voltage power source and a low-voltage power source, two connector pins for a low-voltage power source being inputted to the low-voltage area may not be included.

That is, according to the present embodiment, since only a single power source is inputted from the high-voltage area as a power source for driving the motor control device, the low-voltage area can be used as a minimum space area only for vehicle communication, and the insulating area separating the low-voltage area and the high-voltage area can also be minimized.

A modified embodiment according to the present embodiment may include some components of the first embodiment and some components of the second embodiment together. That is, a modified embodiment may include the first embodiment, but may omit some components of the first embodiment and include some components of the corresponding second embodiment. Or, a modified embodiment may include the second embodiment, but may omit some components of the second embodiment and include some components of the corresponding first embodiment.

The features, structures, effects, and the like described in the embodiments above are included in at least one embodiment, and are not necessarily limited to one embodiment. Furthermore, the features, structures, effects, and the like exemplified in each embodiment can be combined or modified and implemented in other embodiments by a person having ordinary skill in the art to which the embodiments belong. Therefore, the contents related to such combinations and modifications should be interpreted as being included in the scope of the embodiments.

1. A motor control device comprising:
a substrate comprising a low-voltage area, a high-voltage area being spaced apart from the low-voltage area, and an insulating area disposed between the low-voltage area and the high-voltage area; and
a capacitor module disposed in the high-voltage area,
wherein the high-voltage area comprises a connection terminal being configured by one pin map, and
wherein the capacitor module has a pin being formed at a position corresponding to the connection terminal.

2. The motor control device according to claim 1,
wherein the capacitor module comprises a substrate, components disposed on one surface of the substrate, and pins disposed on the other surface of the substrate, and
wherein at least some of the components have sizes and types that vary depending on the magnitude of the input voltage.

3. The motor control device according to claim 1,
wherein the components being disposed on one surface of the capacitor module comprise a Y-capacitor, a filter, and a DC capacitor, and
wherein at least some of the size and type of the DC capacitor vary depending on the magnitude of the input voltage.

4. The motor control device according to claim 1, comprising:
a power module being disposed in the high-voltage area of the substrate,
wherein at least some of the size and type of the power module vary depending on the magnitude of the input voltage.

5. The motor control device according to claim 4,
wherein the connection terminal of the high-voltage area comprises a first connection terminal to which the capacitor module is connected and a second connection terminal to which the power module is connected, and
wherein the power module has pins being formed at a position corresponding to the second connection terminal.

6-10. (canceled)

11. The motor control device according to claim 1,
wherein the low-voltage area comprises a PMIC(Power management integrated circuit), a CAN IC, and an MCU(Micro control unit).

12. The motor control device according to claim 1,
wherein the low-voltage area comprises an isolator and a DCDC converter.

13. The motor control device according to claim 1,
wherein the types of input voltage inputted to the high-voltage area comprises a first voltage, and a second voltage greater that the first voltage, and
wherein the capacitor module comprises a first capacitor module applied when the input voltage is the first voltage and a second capacitor module applied when the input voltage is the second voltage.

14. The motor control device according to claim 13,
wherein the capacitor module comprises a substrate, components disposed on one surface of the substrate, and pins disposed on the other surface of the substrate, and
wherein a size of the substrate of the first capacitor module is smaller than a size of the substrate of the second capacitor module.

15. A capacitor module being disposed in a motor control unit,
wherein the capacitor module comprises:
a substrate;
components being disposed on one surface of the substrate; and
pins being disposed on the other surface of the substrate and formed at a position corresponding to a connection terminal of the motor control device, and
wherein at least some of the sizes and types of the components change depending on the magnitude of the input voltage.

16. The capacitor module according to claim 15,
wherein the components comprise a Y capacitor, a filter and a DC capacitor, and
wherein at least some of the sizes and types of the DC capacitor vary depending on the magnitude of the input voltage.

17. The capacitor module according to claim 15,
wherein the motor control unit comprises a low-voltage area, a high-voltage area being spaced apart from the low-voltage area, and an insulating area disposed between the low-voltage area and the high-voltage area, and
wherein the capacitor module is disposed in the high-voltage area.

18. The capacitor module according to claim 17,
wherein the low-voltage area comprises a PMIC(Power management integrated circuit), a CAN IC, and an MCU(Micro control unit).

19. The capacitor module according to claim 17,
wherein the low-voltage area comprises an isolator and a DCDC converter.

20. A motor control device comprising:
a substrate comprising a low-voltage area, a high-voltage area being spaced apart from the low-voltage area, and an insulating area being disposed between the low-voltage area and the high-voltage area; and
a connection terminal being configured with a single pin map in the high-voltage area,
wherein the connection terminal is connectable to a first capacitor module or a second capacitor module, and
wherein a voltage applicable to the first capacitor module is a first voltage, and a voltage applicable to the second capacitor module is a second voltage greater than the first voltage.

21. A motor control device according to claim 20,
wherein the first capacitor module and the second capacitor module comprise:
a substrate;
a component being disposed on one surface of the substrate; and
a pin being disposed on the other surface of the substrate and formed at a position corresponding to the connection terminal.

22. The motor control device according to claim 21,
wherein a size of the substrate of the first capacitor module is smaller than a size of the substrate of the second capacitor module.

23. The motor control device according to claim 21,
wherein the components comprise a Y capacitor, a filter and a DC capacitor, and
wherein a size of the components of the first capacitor module is smaller than a size of the components of the second capacitor module.

24. The motor control device according to claim 13 comprising:
a power module being disposed in the high-voltage area of the substrate,
wherein the connection terminal comprises a first connection terminal to which the first capacitor module or the second capacitor module is connected and a second connection terminal to which the power module is connected.

25. The motor control device according to claim 20,
wherein the low-voltage area comprises a PMIC (Power management integrated circuit), a CAN IC, and an MCU (Micro control unit).
